(19) United States
(12) Patent Application Publication
(10) Pub. No.: US 2026/0105775 A1
(43) Pub. Date: Apr. 16, 2026

(54) FACE DETECTION METHOD, COMPUTER-READABLE STORAGE MEDIA, AND ELECTRONIC DEVICE

(71) Applicant: UBTECH ROBOTICS CORP LTD, Shenzhen (CN)

(72) Inventors: YUSHENG ZENG, Shenzhen (CN); Pei Dong, Shenzhen (CN)

(21) Appl. No.: 19/231,492

(22) Filed: Jun. 8, 2025

(30) Foreign Application Priority Data
Sep. 11, 2024 (CN) 202411279386.4

(51) Int. Cl. G06V 40/16; G06V 10/25; G06V 10/52; G06V 10/82

(52) U.S. Cl. CPC G06V 40/161; G06V 10/25; G06V 10/52; G06V 10/82

(57) ABSTRACT

A face detection method, a computer-readable storage medium, and an electronic device are provided. The method includes: obtaining the to-be-detected target image; and detecting, using a preset face detection model, the face in the target image; where, a reparameterization module of the face detection model during training includes a plurality of convolution kernels each corresponding to an individual scale of faces. In this manner, during the training of the face detection model, different convolution kernels in the reparameterization module will respectively correspond to faces at different scales, so that different convolution kernels can extract diverse face semantic features in a more extent, thereby effectively improving the performance of the face detection model and obtaining more accurate face detection results.

### CROSS REFERENCE TO RELATED APPLICATIONS

The present disclosure claims priority to Chinese Patent Application No. 202411279386.4, filed Sep. 11, 2024, which is hereby incorporated by reference herein as if set forth in its entirety.

### TECHNICAL FIELD

The present disclosure relates to face detection technology, and particularly to a face detection method, a computer-readable storage medium, and an electronic device.

### BACKGROUND

Face detection is a computer technology for finding the position and size of a face and further accurately positioning subtle features of the face such as eyes, nose, and mouth in any digital image, which provides a basis for subsequent face recognition and analysis.

In the existing technology, it may apply the convolutional reparameterization algorithm to a face detection model by increasing the number of convolution kernels during training, while fusing the parameters of the corresponding convolution kernels during inference, thereby improving the performance of the face detection model without increasing the consumption of inference. However, the face semantic features can be extracted by the existing convolutional reparameterization algorithm during training is limited, which has poor effect on improving the performance of the face detection model.

### BRIEF DESCRIPTION OF DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a flow chart of the training process of a face detection model according to an embodiment of the present disclosure.

FIG. 2 is a schematic diagram of allocating face detection boxes to detection box groups of different scales according to an embodiment of the present disclosure.

FIG. 3 is a schematic diagram of extracting face semantic features using re-parameterized convolution kernels according to an embodiment of the present disclosure.

FIG. 4 is a schematic diagram of extracting face semantic features using multi-scale convolution kernels according to an embodiment of the present disclosure.

FIG. 5 is a flow chart of a face detection method according to an embodiment of the present disclosure.

FIG. 6 is a schematic block diagram of the structure of a face detection apparatus according to an embodiment of the present disclosure.

FIG. 7 is a schematic block diagram of an electronic device according to an embodiment of the present disclosure.

### DETAILED DESCRIPTION

In order to make the objects, features and advantages of the present disclosure more obvious and easy to understand, the technical solutions in the embodiments of the present disclosure will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

It is to be understood that, when used in the description and the appended claims of the present disclosure, the terms “including” and “comprising” indicate the presence of stated features, integers, steps, operations, elements and/or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “one”, “a”, and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

As used in the description and the appended claims, the term “if” may be interpreted as “when” or “once” or “in response to determining” or “in response to detecting” according to the context. Similarly, the phrase “if determined” or “if [the described condition or event] is detected” may be interpreted as “once determining” or “in response to determining” or “on detection of [the described condition or event]” or “in response to detecting [the described condition or event]”.

In addition, in the present disclosure, the terms “first”, “second”, “third”, and the like in the descriptions are only used for distinguishing, and cannot be understood as indicating or implying relative importance.

Face detection is a computer technology for finding the position and size of a face and further accurately positioning subtle features of the face such as eyes, nose, and mouth in any digital image, which provides a basis for subsequent face recognition and analysis.

In the existing technology, it may apply the convolutional reparameterization algorithm to a face detection model by increasing the number of convolution kernels during training, while fusing the parameters of the corresponding convolution kernels during inference, thereby improving the performance of the face detection model without increasing the consumption of inference. However, the face semantic features can be extracted by the existing convolutional reparameterization algorithm during training is limited, which has poor effect on improving the performance of the face detection model.

In view of this, the embodiments of the present disclosure provide a face detection method, an apparatus, a computer-readable storage medium, and an electronic device to solve the problem that the existing convolutional reparameterization algorithm can only extract limited face semantic features during training and have poor effect on improving the performance of the face detection model.

In the embodiments of the present disclosure, the subject of executions may be an electronic device that is a computing device such as a mobile phone, a tablet computer, desktop computer, notebook computer, a handheld computer, a robot, or a server. It should be noted that the electronic device for model training and that for face detection may be the same electronic device or different electronic devices. That is, the model training may be performed in one electronic device, and the trained model may be deployed to another electronic device for the face detection.

In the embodiments of the present disclosure, the specific model structure of the face detection model may be flexibly set according to actual conditions, which may include at least one of an active shape model (ASM), an active appearance model (AAM), a cascaded pose regression (CPR), a deep convolutional network (DCNN), a task-constrained deep convolutional network (TCDCN), a multi-task cascaded convolutional network (MTCNN), a tweaked convolutional neural network (TCNN), and a deep alignment network (DAN).

In the embodiments of the present disclosure, during the training of the face detection model, different convolution kernels in the reparameterization module can be made to correspond to different scales of faces, so that different convolution kernels can extract more diverse face semantic features, thereby effectively improving the performance of the face detection model and obtaining more accurate face detection results. In which, the number of the convolution kernels in the reparameterization module are denoted as N, where N is an integer larger than or equal to 2, and its specific value may be flexibly set according to actual conditions.

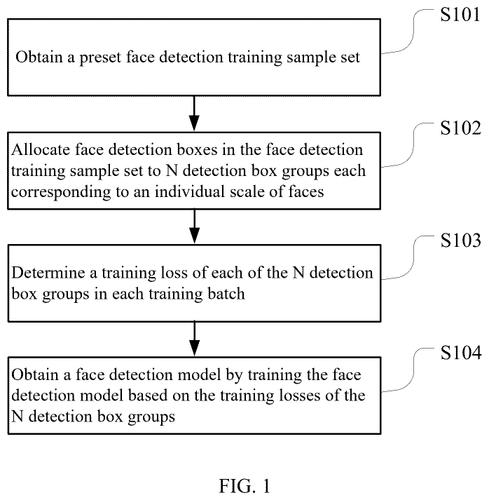

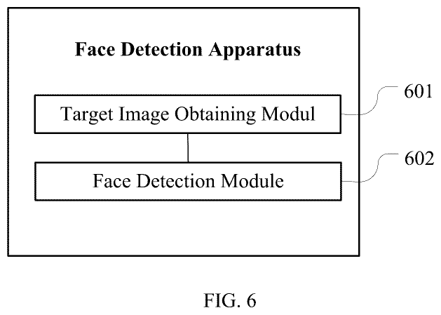

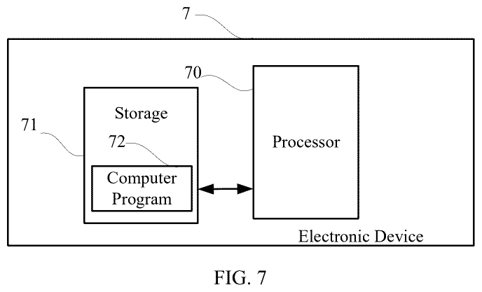

FIG. 1 is a flow chart of the training process of a face detection model according to an embodiment of the present disclosure. In this embodiment, the face detection method may be applied to (a processor of) an electronic device that detects faces in images. If the electronic device is, for example, a humanoid robot including a head part, the images may be captured through a camera installed on the head part. In other embodiments, the method may be implemented through a face detection apparatus as shown in FIG. 6 or an electronic device as shown in FIG. 7. As shown in FIG. 1, the face detection method may include the following steps.

S101: obtaining a preset face detection training sample set.

In order to obtain the face detection model for realizing a face detection function of the electronic device, it may train the model using the preset face detection training sample set. In which, the face detection training sample set may include sample images of faces at various scales (i.e., each sample image corresponds to an individual scale of faces), where each of the sample images is pre-labeled with a corresponding face detection box.

S102: allocating the face detection boxes in the face detection training sample set to N detection box groups each corresponding to the individual scale of faces.

In which, the n-th detection box group corresponds to the n-th convolution kernel in the reparameterization module, where 1≤n≤N.

In this embodiment, as an example, it may set N-1 area thresholds in advance to denote as AreaT₁, AreaT₂, AreaT₃, . . . , AreaT_{N-2}, AreaT_{N-1}, respectively in order from large to small. For any face detection box, the area of the face detection box is denoted as Area. If Area>AreaT₁, it may be allocated to the 1-st detection box group, that is, the face detection box group of the largest scale; if AreaT₂□Area≤AreaT₁, it may be allocated to the 2-nd detection box group, that is, the face detection box group of the second largest scale; if AreaT₃<Area≤AreaT₂, it may be allocated to the 3-rd detection box group; . . . ; if AreaT_{N-1}<Area≤AreaT_{N-2}, it may be allocated to the N-1-th detection box grouped, that is, the face detection box group of the second smallest scale; and if Area≤AreaT_{N-1}, it may be allocated to the N-th detection box grouped, that is, the face detection box group of the smallest scale. The specific value of each area threshold may be flexibly set according to actual conditions.

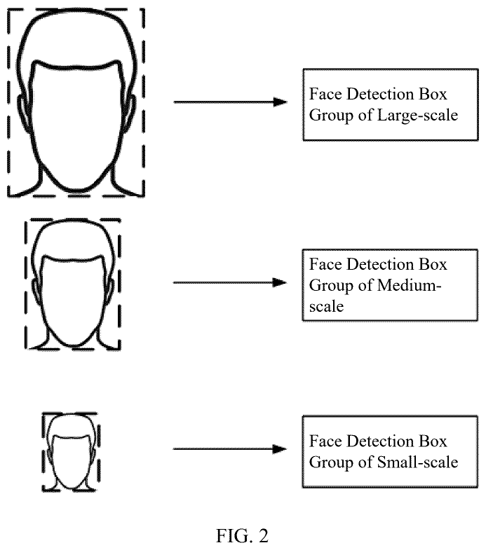

Taking N=3 as an example, a first area threshold and a second area threshold may be set in advance, where the first area threshold is larger than the second area threshold. FIG. 2 is a schematic diagram of allocating face detection boxes to detection box groups of different scales according to an embodiment of the present disclosure. As shown in FIG. 2, for any face detection box, if the area of the face detection box is larger than the first area threshold, it may be allocated to the first detection box group, that is, the face detection box group of large-scale; if the area of the face detection box is smaller than or equal to the first area threshold and larger than the second area threshold, it may be allocated to the second detection box group, that is, the face detection box group of medium-scale; and if the area of the face detection box is smaller than or equal to the second area threshold, it may be allocated to the third detection box group, that is, the face detection box group of small-scale.

S103: determining a training loss of each of the N detection box groups in each training batch.

For any sample image, it may be input into the face detection model for processing to obtain the face detection result output by the face detection model. Based on the difference between the pre-labeled face detection box and the actual face detection box in the face detection result, the corresponding training loss may be determined.

In this embodiment, as an example, the training losses of each face detection box belonging to the same detection box group may be summed to obtain the training loss of the detection box group.

S104: obtaining a face detection model by training the face detection model based on the training losses of the N detection box groups.

The specific type of each convolution kernel in the reparameterization module may be flexibly set according to actual conditions. In this embodiment, as an example, the convolution kernel corresponding to the minimum-scale face may be a central differential convolution (CDC) kernel that can extract the difference between the current pixel value and the surrounding positions. In comparison with other convolution kernels, it can extract edge information in a better manner, and is more suitable for extracting features of small-scale faces. The other convolution kernels in the reparameterization module may be the convolution kernels other than the central differential convolution kernel.

In the process of backpropagation according to the training loss, taking any convolution kernel in the reparameterization module that is denoted as a target convolution kernel as an example, for the target convolution kernel, the gradients of the training loss of the N detection box groups may be determined respectively, and the total gradient corresponding to the target convolution kernel may be determined based on the gradient of the training loss of the N detection box groups and a preset gradient weight of the N detection box groups.

In which, the gradient weight of the first detection box group is larger than that of the second detection box group. The first detection box group is a detection box group corresponding to the target convolution kernel, and the second detection box group is one of the N detection box groups other than the first detection box group. The specific value of each gradient weight may be flexibly set according to actual conditions.

After obtaining the total gradient corresponding to the target convolution kernel, the model parameters of the target convolution kernel may be adjusted according to the total gradient.

Taking N=3 as an example, the reparameterization module may include a first convolution kernel, a second convolution kernel, and a third convolution kernel. In which, the face scale corresponding to the first convolution kernel is larger than that corresponding to the second convolution kernel, and the face scale corresponding to the second convolution kernel is larger than that corresponding to the third convolution kernel. In which, the detection box group corresponding to the first convolution kernel may be denoted as the first detection box group, the detection box group corresponding to the second convolution kernel may be denoted as the second detection box group, and the detection box group corresponding to the third convolution kernel may be denoted as the third detection box group.

In the case that the target convolution kernel is the first convolution kernel, a first weighted gradient of the first detection box group may be determined based on the gradient of the training loss of the first detection box group and a first gradient weight of the first detection box group, as an equation of: w_grad₁₁=grad₁₁×w₁₁, where grad₁₁ is the gradient of the training loss of the first detection box group for the first convolution kernel, w₁₁ is the first gradient weight of the first detection box group that may be set to a value such as 1, and w_grad₁₁ is the first weighted gradient of the first detection box group.

The first weighted gradient of the second detection box group may be determined based on the gradient of the training loss of the second detection box group and a first gradient weight of the second detection box group, as an equation of: w_grad₂₁=grad₂₁×w₂₁, where grad₂₁ is the gradient of the training loss of the second detection box group for the first convolution kernel, w₂₁ is the first gradient weight of the second detection box group that may be set to a value such as 0.5, and w_grad₂₁ is the first weighted gradient of the second detection box group.

The first weighted gradient of the third detection box group may be determined based on the gradient of the training loss of the third detection box group and a first gradient weight of the third detection box group, as an equation of: w_grad₃₁=grad₃₁×w₃₁, where grad₃₁ is the gradient of the training loss of the third detection box group for the first convolution kernel, w₃₁ is the first gradient weight of the third detection box group hat may be set to a value such as 0.5, and w_grad₃₁ is the first weighted gradient of the third detection box group.

Finally, the total gradient corresponding to the first convolution kernel may be determined based on the first weighted gradient of the first detection box group, the first weighted gradient of the second detection box group, and the first gradient weight of the third detection box group, as an equation of: w_grad₁=w_grad₁₁+w_grad₂₁+w_grad₃₁, where w_grad₁ is the total gradient corresponding to the first convolution kernel. After obtaining the total gradient corresponding to the first convolution kernel, the model parameters of the first convolution kernel may be adjusted according to the total gradient.

In the case that the target convolution kernel is the second convolution kernel, the second weighted gradient of the first detection box group may be determined based on the gradient of the training loss of the first detection box group and ta second gradient weight of the first detection box group, as an equation of: w_grad₁₂=grad₁₂×w₁₂, where grad₁₂ is the gradient of the training loss of the first detection box group for the second convolution kernel, w₁₂ is the second gradient weight of the first detection box group that may be set to a value such as 0.5, and w_grad₁₂ is the second weighted gradient of the first detection box group.

The second weighted gradient of the second detection box group may be determined based on the gradient of the training loss of the second detection box group and a second gradient weight of the second detection box group, as an equation of: w_grad₂₂=grad₂₂×w₂₂, where grad₂₂ is the gradient of the training loss of the second detection box group for the second convolution kernel, w₂₂ is the second gradient weight of the second detection box group that may be set to a value such as 1, and w_grad₂₂ is the second weighted gradient of the second detection box group.

The second weighted gradient of the third detection box group may be determined based on the gradient of the training loss of the third detection box group and a second gradient weight of the third detection box group, as an equation of: w_grad₃₂=grad₃₂×w₃₂, where grad₃₂ is the gradient of the training loss of the third detection box group for the second convolution kernel, w₃₂ is the second gradient weight of the third detection box group that may be set to a value such as 0.3, and w_grad₃₂ is the second weighted gradient of the third detection box group.

Finally, the total gradient corresponding to the second convolution kernel may be determined based on the second weighted gradient of the first detection box group, the second weighted gradient of the second detection box group, and the second weighted gradient of the third detection box group, as an equation of: w_grad₂=w_grad₁₂+w_grad₂₂+w_grad₃₂, where w_grad₂ is the total gradient corresponding to the second convolution kernel. After obtaining the total gradient corresponding to the second convolution kernel, the model parameters of the second convolution kernel may be adjusted according to the total gradient.

In the case that the target convolution kernel is the third convolution kernel, the third weighted gradient of the first detection box group may be determined based on the gradient of the training loss of the first detection box group and a third gradient weight of the first detection box group, as an equation of: w_grad₁₃=grad₁₃×w₁₃, where grad₁₃ is the gradient of the training loss of the first detection box group for the third convolution kernel, w₁₃ is the third gradient weight of the first detection box group that may be set to a value such as 0.1, and w_grad₁₃ is the third weighted gradient of the first detection box group.

The third weighted gradient of the second detection box group may be determined based on the gradient of the training loss of the second detection box group and a third gradient weight of the second detection box group, as an equation of: w_gra_{d23}=grad₂₃×w₂₃, where grad₂₃ is the gradient of the training loss of the second detection box group for the third convolution kernel, w₂₃ is the third gradient weight of the second detection box group that may be set to a value such as 0.1, and w_grad₂₃ is the third weighted gradient of the second detection box group.

The third weighted gradient of the third detection box group may be determined based on the gradient of the training loss of the third detection box group and a third gradient weight of the third detection box group, as an equation of: w_grad₃₃=grad₃₃×w₃₃, where grad₃₃ is the gradient of the training loss of the third detection box group for the third convolution kernel, w₃₃ is the third gradient weight of the third detection box group that may be set to a value such as 1, and w_grad₃₃ is the third weighted gradient of the third detection box group.

Finally, the total gradient corresponding to the third convolution kernel may be determined based on the third weighted gradient of the first detection box group, the third weighted gradient of the second detection box group, and the third weighted gradient of the third detection box group, as an equation of: w_grad₃=w_grad₁₃+w_grad₂₃+w_grad₃₃, where w_grad₃ is the total gradient corresponding to the third convolution kernel. After obtaining the total gradient corresponding to the third convolution kernel, the model parameters of the third convolution kernel may be adjusted according to the total gradient.

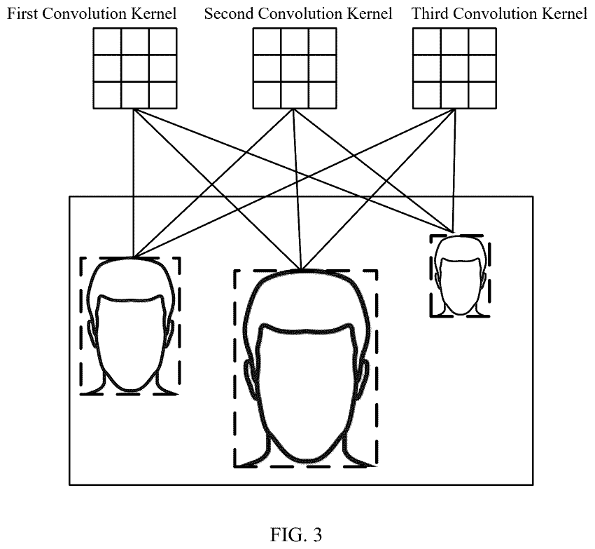

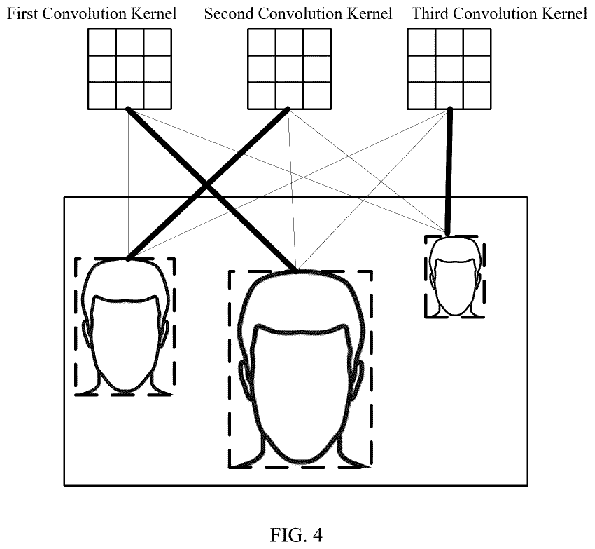

FIG. 3 is a schematic diagram of extracting face semantic features using re-parameterized convolution kernels according to an embodiment of the present disclosure. As shown in the FIG. 3, since different scales of faces are processed by convolution kernels in the same manner, the gradient difference between different convolution kernels will be inadequate to cause the difficulty in extracting richer face semantic features. FIG. 4 is a schematic diagram of extracting face semantic features using multi-scale convolution kernels according to an embodiment of the present disclosure. As shown in the FIG. 4, by restricting the flow direction of the gradients of faces at different scales with respect to different convolution kernels (i.e., multi-scale convolution kernels) in the re-parameterization module such that different convolution kernels pay attention to the features of faces at different scales (emphasized by bolded straight lines), richer face semantic features can be extracted, thereby better tapping the potential of re-parameterized convolution.

It should be noted that the foregoing description is to illustrate the adjustment process of the model parameters using one training batch as an example, while a plurality of training rounds each including a plurality of training batches may be performed in an actual training process so as to constantly repeat the foregoing process until a preset training condition is met. In which, the training condition may be that the training round reaches a preset number threshold that may be set according to actual condition, for example, it may be set to a value of thousands, tens of thousands, hundreds of thousands, or even larger. Alternatively, the training condition may also be the convergence of the face detection model. Because there will be two cases that the face detection model converges while the training round not reaches the number threshold and repetitive unnecessary work is caused, and that the face detection model cannot converge and infinite loops is caused so that the training process cannot be ended, the training condition may also be that the training round reaches the number threshold or the face detection model converges. The trained face detection model can be obtained while the training condition is met.

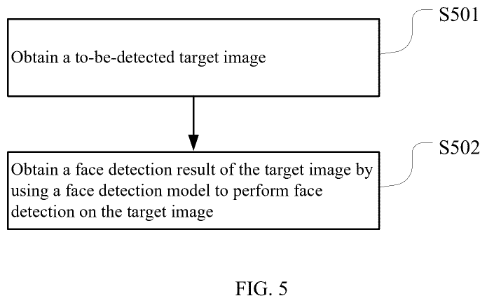

The structure of the trained face detection model may be re-parameterized based on the trained face detection model to obtain the face detection model for actual use, then the obtained face detection model may be used for actual face detection. FIG. 5 is a flow chart of a face detection method according to an embodiment of the present disclosure. As shown in FIG. 5, in this embodiment, the face detection method may include the following steps.

S501: obtaining the to-be-detected target image.

In this embodiment, as an example, the target image may be obtained directly through a visual sensor (e.g., a camera) of the electronic device. As an example, the electronic device may obtain one frame of image at a certain interval to form an image sequence or video stream. The collected image type may be set according to actual conditions, which may include RGB images.

As another example, the target image may be collected through other device and transmitted to the electronic device through a preset data transmission link.

It should be noted that the “target image” refers to a frame of image currently being processed by the electronic device that is a dynamic object rather than a certain frame of image. For instance, if the electronic device first processes the image obtained for the first time to denote as Image 1, the target image is Image 1. After the electronic device has processed Image 1, it continues to process the image obtained for the second time to denote as Image 2, and the target image is Image 2. After the electronic device has processed Image 2, it continues to process the image obtained for the third time to denote as Image 3, and the target image is Image 3, . . . , and so on.

S502: obtaining a face detection result of the target image by using the face detection model to perform face detection on the target image.

In this embodiment, it may input the target image into the human-face detection model for processing to obtain the output of the human-face detection model, that is, the face detection result of the target image.

To sum up, in this embodiment, during the training of the face detection model, it makes different convolution kernels in the reparameterization module to correspond to faces at different scales, so that different convolution kernels can extract more diverse face semantic features, thereby effectively improving the performance of the face detection model and obtaining more accurate face detection results.

It should be noted that in this embodiment, the information collection process (e.g., the collection process of face images)/feature extraction process is performed with the user's knowledge and permission, that is, the information collection process/feature extraction process will meet relevant requirements and not hinder public interests.

It should be understood that, the sequence of the serial number of the steps in the above-mentioned embodiments does not mean the execution order while the execution order of each process should be determined by its function and internal logic, which should not be taken as any limitation to the implementation process of the embodiments.

FIG. 6 is a schematic block diagram of the structure of a face detection apparatus according to an embodiment of the present disclosure. As shown in FIG. 6, in this embodiment, a face detection apparatus corresponding to the face detection method described in the foregoing embodiment is provided.

In this embodiment, the face detection apparatus may include:
a target image obtaining module 601 configured to obtain a to-be-detected target image; and
a face detection module 602 configured to detect, using a preset face detection model, a face in the target image to obtain a face detection result of the target image;
where, a reparameterization module of the face detection model during training includes N convolution kernels corresponding to faces at different scales, and N is an integer larger than or equal to 2.

In one embodiment, the face detection apparatus may further include:
a training sample set obtaining module configured to obtain a preset face detection training sample set;
a detection box grouping module configured to allocate face detection boxes in the face detection training sample set to N detection box groups each corresponding to the face the individual scale of faces, where the n-th detection box group corresponds to the n-th convolution kernel among the N convolution kernels in the reparameterization module, 1≤n≤N, where N is an integer larger than or equal to 2;
a training loss determining module configured to determine a training loss of each of the N detection box groups in each training batch; and
a model training module configured to obtain the face detection model by training the face detection model based on the training losses of the N detection box groups.

In one embodiment, the model training module may include:
a gradient determining unit configured to, for a target convolution kernel, determine a gradient of the training loss of each of the N detection box groups, where the target convolution kernel is any of the N convolution kernels in the re-parameterization module;
a total gradient determining unit configured to determine a total gradient corresponding to the target convolution kernel based on the gradients of the training losses of the N detection box groups and preset gradient weights of the N detection box groups, where the gradient weight of the first detection box group is larger than the gradient weight of the second detection box group, the first detection box group is a detection box group corresponding to the target convolution kernel, and the second detection box group is one of the N detection box groups other than the first detection box group; and
a parameter adjusting unit configured to adjust, based on the total gradient corresponding to the target convolution kernel, a model parameter of the target convolution kernel.

In one embodiment, the reparameterization module may include a first convolution kernel, a second convolution kernel, and a third convolution kernel, and the face at the scale corresponding to the first convolution kernel is larger than the face at the scale corresponding to the second convolution kernel, and the face at the scale corresponding to the second convolution kernel is larger than the face at the scale corresponding to the third convolution kernel;

The total gradient determining unit may include:
a first total gradient determining subunit configured to determine, based on the gradient of the training loss of the first detection box group and a first gradient weight of the first detection box group, a first weighted gradient of the first detection box group in response to the target convolution kernel being the first convolution kernel, where the first detection box group is a detection box group corresponding to the first convolution kernel; determine, based on the gradient of the training loss of the second detection box group and a first gradient weight of the second detection box group, a first weighted gradient of the second detection box group, where the second detection box group is a detection box group corresponding to the second convolution kernel; determine, based on the gradient of the training loss of a third detection box group and a first gradient weight of the third detection box group, a first weighted gradient of the third detection box group, where the third detection box group is a detection box group corresponding to the third convolution kernel; and determine, based on the first weighted gradient of the first detection box group, the first weighted gradient of the second detection box group, and the first weighted gradient of the third detection box group, a total gradient corresponding to the first convolution kernel.

In one embodiment, the total gradient determining unit may further include:
a second total gradient determining subunit configured to determine, based on the gradient of the training loss of the first detection box group and a second gradient weight of the first detection box group, a second weighted gradient of the first detection box group in response to the target convolution kernel being the second convolution kernel; determine, based on the gradient of the training loss of the second detection box group and a second gradient weight of the second detection box group, a second weighted gradient of the second detection box group; determine, based on the gradient of the training loss of the third detection box group and a second gradient weight of the third detection box group, a second weighted gradient of the third detection box group; and determine, based on the second weighted gradient of the first detection box group, the second weighted gradient of the second detection box group, and the second weighted gradient of the third detection box group, a total gradient corresponding to the second convolution kernel.

In one embodiment, the total gradient determining unit may further include:
a third total gradient determining subunit configured to determine, based on the gradient of the training loss of the first detection box group and a third gradient weight of the first detection box group, a third weighted gradient of the first detection box group in response to the target convolution kernel being the third convolution kernel; determine, based on the gradient of the training loss of the second detection box group and a third gradient weight of the second detection box group, a third weighted gradient of the second detection box group; determine, based on the gradient of the training loss of the third detection box group and a third gradient weight of the third detection box group, a third weighted gradient of the third detection box group; and determine, based on the third weighted gradient of the first detection box group, the third weighted gradient of the second detection box group, and the third weighted gradient of the third detection box group, a total gradient corresponding to the third convolution kernel.

In one embodiment, the convolution kernel in the reparameterization module that corresponds to the face at the minimum scale may be a center differential convolution kernel.

Those skilled in the art may clearly understand that, for the convenience and simplicity of description, for the specific operation process of the above-mentioned apparatus, modules and units, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

FIG. 7 is a schematic block diagram of an electronic device 7 according to an embodiment of the present disclosure. For ease of illustration, only parts related to this embodiment are shown.

As shown in FIG. 7, in this embodiment, the electronic device 7 may include a processor 70, a storage 71, and a computer program 72 stored in the storage 71 and executed on the processor 70. When the processor 70 executes the computer program 72, the steps in the above-mentioned embodiment of the face detection method, for example, steps S501-S502 shown in FIG. 5 are implemented, or the functions of each module/unit of the above-mentioned apparatus embodiment, for example, modules 601-602 shown in FIG. 6 are implemented.

As an example, the computer program 72 may be separated into one or more modules/units, and the one or more modules/units are stored in the storage 71 and executed by the processor 70 to complete a sequence of computer program instruction sections that may complete particular functions. The computer program 72 is configured to describe the execution process of the computer program 72 in the apparatus 7.

The electronic device 7 may be a computing device such as mobile phone, a tablet computer, a desktop computer, a notebook computer, a handheld computer, a robot, and a server. It can be understood by those skilled in the art that FIG. 7 is merely an example of the electronic device 7 and does not constitute a limitation on the electronic device 7, and may include more or fewer components than those shown in the figure, or a combination of some components or different components. For example, the electronic device 7 may further include an input/output device, a network access device, a bus, and the like.

The processor 70 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 71 may be an internal storage unit of the electronic device 7, for example, a hard disk or a memory of the electronic device 7. The storage 71 may also be an external storage device of the electronic device 7, for example, a plug-in hard disk, a smart media card (SMC), a secure digital (SD) card, flash card, and the like, which is equipped on the electronic device 7. Furthermore, the storage 71 may further include both an internal storage unit and an external storage device, of the electronic device 7. The storage 71 is configured to store the computer program 72 and other programs and data required by the electronic device 7. The storage 71 may also be used to temporarily store data that has been or will be output.

Those skilled in the art may clearly understand that, for the convenience and simplicity of description, the division of each of the foregoing-mentioned functional units and modules is merely an example for illustration. In actual applications, the foregoing-mentioned functions may be allocated to be performed by different functional units according to requirements, that is, the internal structure of the device may be allocated to different functional units or modules to complete all or part of the foregoing-mentioned functions. each functional unit in the embodiments may be integrated into one processing unit, or each unit may exist alone physically, or two or more units may be integrated in one unit. The foregoing-mentioned integrated unit may be implemented in the form of hardware or in the form of software functional unit. In addition, the specific name of each functional unit and the module is merely for the convenience of distinguishing each other and is not intended to limit the scope of each protection unit and the specific operation process of the foregoing-mentioned system of the foregoing-mentioned system, reference may be made to the corresponding processes in the foregoing-mention

In the above-mentioned embodiments, the description of each embodiment has its focuses, and the parts which are not described or mentioned in one embodiment may refer to the related descriptions in other embodiments.

Those skilled in the art may clearly understand that, the exemplificative units and steps described in the embodiments disclosed herein may be implemented in electronic hardware or a combination of computer software and electronic hardware. Whether these functions are implemented through hardware or software depends on the specific application and design constraints of the technical schemes. Those ordinary skilled in the art may implement the described functions in different manners for each particular application, while this implementation should not be considered as be within the scope of the present disclosure.

In the embodiments provided by the present disclosure, it should be noted that the disclosed apparatus/electronic device and method may be implemented in other manners. For example, the foregoing-mentioned apparatus/electronic device embodiment is merely exemplary. For example, the division of modules or units is merely a logical functional division, and other division manner may be used in actual implementations, for example, multiple units or components may be combined or be integrated into another system, or some of the features may be ignored or not performed. In addition, the discussed or disclosure may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the purpose of this embodiment.

In addition, each functional unit in each embodiment of the present disclosure may be integrated into one processing unit, or each unit may exist physically only, or two or more units may be integrated in one unit. The foregoing-mentioned integrated unit may be implemented in the form of hardware or in the form of software functional unit.

If the integrated module/unit is implemented in the form of a software functional unit and sold or used as an independent product, it can be stored in a computer-readable storage medium. Based on this understanding, the present disclosure realizes all or part of the flow of the above-mentioned embodiment method, and can also be completed by instructing relevant hardware by computer programs. The computer program can be stored in a computer-readable storage medium. When the computer program is executed by a processor, it can implement the steps of the above-mentioned method embodiments. In which, the computer program includes computer program code, which can be in the form of source code, object code, executable file or some intermediate forms, etc. The computer-readable storage medium may include: any entity or device capable of carrying the computer program code, a recording medium, a USB flash drive, a mobile hard disk, a magnetic disk, an optical disk, a computer memory, a read-only memory (ROM), a random access memory (RAM), an electric carrier signal, a telecommunication signal and a software distribution medium, etc. It should be noted that the content contained in the computer-readable storage medium can be appropriately increased and decreased according to the requirements of legislation and patent practices in the jurisdiction. For example, in some jurisdictions, according to legislation and patent practices, the computer-readable storage medium does not include electric carrier signal and telecommunication signal.

The foregoing-mentioned embodiments are merely intended for describing but not for limiting the technical schemes of the present disclosure. Although the present disclosure is described in detail with reference to the foregoing-mentioned embodiments, it should be noted by those skilled in the art that, the technical schemes in each of the foregoing-mentioned embodiments may still be modified, or some of the technical features may be equivalently replaced. These modifications or replacements do not make the essence of the corresponding technical schemes depart from the spirit and scope of the technical schemes of each of the embodiments of the present disclosure, and should be included within the scope of the present disclosure.

What is claimed is:

1. A method for detecting a face in a to-be-detected target image, comprising:
obtaining the to-be-detected target image; and
detecting, using a preset face detection model, the face in the target image;
wherein, a reparameterization module of the face detection model during training includes a plurality of convolution kernels each corresponding to an individual scale of faces.

2. The method of claim 1, wherein the face detection model is trained by:
obtaining a preset face detection training sample set;
allocating face detection boxes in the face detection training sample set to N detection box groups each corresponding to the individual scale of faces, wherein the n-th detection box group corresponds to the n-th convolution kernel among the N convolution kernels in the reparameterization module, 1≤n≤N, wherein N is an integer larger than or equal to 2;
determining a training loss of each of the N detection box groups in each training batch; and
obtaining the face detection model by training the face detection model based on the training losses of the N detection box groups.

3. The method of claim 2, wherein training the face detection model based on the training losses of the N detection box groups comprises:
for a target convolution kernel, determining a gradient of the training loss of each of the N detection box groups, wherein the target convolution kernel is any of the N convolution kernels in the re-parameterization module;
determining a total gradient corresponding to the target convolution kernel based on the gradients of the training losses of the N detection box groups and preset gradient weights of the N detection box groups, wherein the gradient weight of the first detection box group is larger than the gradient weight of the second detection box group, the first detection box group is a detection box group corresponding to the target convolution kernel, and the second detection box group is one of the N detection box groups other than the first detection box group; and
adjusting, based on the total gradient corresponding to the target convolution kernel, a model parameter of the target convolution kernel.

4. The method of claim 3, wherein the reparameterization module includes a first convolution kernel, a second convolution kernel, and a third convolution kernel, and the face at the scale corresponding to the first convolution kernel is larger than the face at the scale corresponding to the second convolution kernel, and the face at the scale corresponding to the second convolution kernel is larger than the face at the scale corresponding to the third convolution kernel;
determining the total gradient corresponding to the target convolution kernel based on the gradients of the training losses of the N detection box groups and preset gradient weights of the N detection box groups comprises:
determining, based on the gradient of the training loss of the first detection box group and a first gradient weight of the first detection box group, a first weighted gradient of the first detection box group in response to the target convolution kernel being the first convolution kernel, wherein the first detection box group is a detection box group corresponding to the first convolution kernel;
determining, based on the gradient of the training loss of the second detection box group and a first gradient weight of the second detection box group, a first weighted gradient of the second detection box group, wherein the second detection box group is a detection box group corresponding to the second convolution kernel;
determining, based on the gradient of the training loss of a third detection box group and a first gradient weight of the third detection box group, a first weighted gradient of the third detection box group, wherein the third detection box group is a detection box group corresponding to the third convolution kernel; and
determining, based on the first weighted gradient of the first detection box group, the first weighted gradient of the second detection box group, and the first weighted gradient of the third detection box group, a total gradient corresponding to the first convolution kernel.

5. The method of claim 4, wherein determining the total gradient corresponding to the target convolution kernel based on the gradients of the training losses of the N detection box groups and preset gradient weights of the N detection box groups further comprises:
determining, based on the gradient of the training loss of the first detection box group and a second gradient weight of the first detection box group, a second weighted gradient of the first detection box group in response to the target convolution kernel being the second convolution kernel;
determining, based on the gradient of the training loss of the second detection box group and a second gradient weight of the second detection box group, a second weighted gradient of the second detection box group;
determining, based on the gradient of the training loss of the third detection box group and a second gradient weight of the third detection box group, a second weighted gradient of the third detection box group; and
determining, based on the second weighted gradient of the first detection box group, the second weighted gradient of the second detection box group, and the second weighted gradient of the third detection box group, a total gradient corresponding to the second convolution kernel.

6. The method of claim 4, wherein determining the total gradient corresponding to the target convolution kernel based on the gradients of the training losses of the N detection box groups and preset gradient weights of the N detection box groups further comprises:
determining, based on the gradient of the training loss of the first detection box group and a third gradient weight of the first detection box group, a third weighted gradient of the first detection box group in response to the target convolution kernel being the third convolution kernel;
determining, based on the gradient of the training loss of the second detection box group and a third gradient weight of the second detection box group, a third weighted gradient of the second detection box group;
determining, based on the gradient of the training loss of the third detection box group and a third gradient weight of the third detection box group, a third weighted gradient of the third detection box group; and
determining, based on the third weighted gradient of the first detection box group, the third weighted gradient of the second detection box group, and the third weighted gradient of the third detection box group, a total gradient corresponding to the third convolution kernel.

7. The method of claim 1, wherein the convolution kernel in the reparameterization module that corresponds to the face at the minimum scale is a center differential convolution kernel.

8. A non-transitory computer-readable storage medium for storing one or more computer programs, wherein the one or more computer programs comprise:
instructions for obtaining a to-be-detected target image; and
instructions for detecting, using a preset face detection model, a face in the target image, wherein a reparameterization module of the face detection model during training includes a plurality of convolution kernels each corresponding to an individual scale of faces.

9. The storage medium of claim 8, wherein the face detection model is trained by:
obtaining a preset face detection training sample set;
allocating face detection boxes in the face detection training sample set to N detection box groups each corresponding to the individual scale of faces, wherein the n-th detection box group corresponds to the n-th convolution kernel among the N convolution kernels in the reparameterization module, 1≤n≤N, wherein N is an integer larger than or equal to 2;
determining a training loss of each of the N detection box groups in each training batch; and
obtaining the face detection model by training the face detection model based on the training losses of the N detection box groups.

10. The storage medium of claim 9, wherein the instructions for training the face detection model based on the training losses of the N detection box groups comprise:
instructions for, for a target convolution kernel, determining a gradient of the training loss of each of the N detection box groups, wherein the target convolution kernel is any of the N convolution kernels in the re-parameterization module;
instructions for determining a total gradient corresponding to the target convolution kernel based on the gradients of the training losses of the N detection box groups and preset gradient weights of the N detection box groups, wherein the gradient weight of the first detection box group is larger than the gradient weight of the second detection box group, the first detection box group is a detection box group corresponding to the target convolution kernel, and the second detection box group is one of the N detection box groups other than the first detection box group; and
instructions for adjusting, based on the total gradient corresponding to the target convolution kernel, a model parameter of the target convolution kernel.

11. The storage medium of claim 10, wherein the reparameterization module includes a first convolution kernel, a second convolution kernel, and a third convolution kernel, and the face at the scale corresponding to the first convolution kernel is larger than the face at the scale corresponding to the second convolution kernel, and the face at the scale corresponding to the second convolution kernel is larger than the face at the scale corresponding to the third convolution kernel;
the instructions for determining the total gradient corresponding to the target convolution kernel based on the gradients of the training losses of the N detection box groups and preset gradient weights of the N detection box groups comprise:
instructions for determining, based on the gradient of the training loss of the first detection box group and a first gradient weight of the first detection box group, a first weighted gradient of the first detection box group in response to the target convolution kernel being the first convolution kernel, wherein the first detection box group is a detection box group corresponding to the first convolution kernel;
instructions for determining, based on the gradient of the training loss of the second detection box group and a first gradient weight of the second detection box group, a first weighted gradient of the second detection box group, wherein the second detection box group is a detection box group corresponding to the second convolution kernel;
instructions for determining, based on the gradient of the training loss of a third detection box group and a first gradient weight of the third detection box group, a first weighted gradient of the third detection box group, wherein the third detection box group is a detection box group corresponding to the third convolution kernel; and
instructions for determining, based on the first weighted gradient of the first detection box group, the first weighted gradient of the second detection box group, and the first weighted gradient of the third detection box group, a total gradient corresponding to the first convolution kernel.

12. The storage medium of claim 11, wherein the instructions for determining the total gradient corresponding to the target convolution kernel based on the gradients of the training losses of the N detection box groups and preset gradient weights of the N detection box groups further comprise:
instructions for determining, based on the gradient of the training loss of the first detection box group and a second gradient weight of the first detection box group, a second weighted gradient of the first detection box group in response to the target convolution kernel being the second convolution kernel;
instructions for determining, based on the gradient of the training loss of the second detection box group and a second gradient weight of the second detection box group, a second weighted gradient of the second detection box group;
instructions for determining, based on the gradient of the training loss of the third detection box group and a second gradient weight of the third detection box group, a second weighted gradient of the third detection box group; and
instructions for determining, based on the second weighted gradient of the first detection box group, the second weighted gradient of the second detection box group, and the second weighted gradient of the third detection box group, a total gradient corresponding to the second convolution kernel.

13. The storage medium of claim 11, wherein the instructions for determining the total gradient corresponding to the target convolution kernel based on the gradients of the training losses of the N detection box groups and preset gradient weights of the N detection box groups further comprise:
instructions for determining, based on the gradient of the training loss of the first detection box group and a third gradient weight of the first detection box group, a third weighted gradient of the first detection box group in response to the target convolution kernel being the third convolution kernel;
instructions for determining, based on the gradient of the training loss of the second detection box group and a third gradient weight of the second detection box group, a third weighted gradient of the second detection box group;
instructions for determining, based on the gradient of the training loss of the third detection box group and a third gradient weight of the third detection box group, a third weighted gradient of the third detection box group; and
instructions for determining, based on the third weighted gradient of the first detection box group, the third weighted gradient of the second detection box group, and the third weighted gradient of the third detection box group, a total gradient corresponding to the third convolution kernel.

14. An electronic device for detecting a face in a to-be-detected target image, comprising:
a processor;
a memory coupled to the processor; and
one or more computer programs stored in the memory and executable on the processor;
wherein, the one or more computer programs comprise:
instructions for obtaining the to-be-detected target image; and
instructions for detecting, using a preset face detection model, the face in the target image, wherein a reparameterization module of the face detection model during training includes a plurality of convolution kernels each corresponding to an individual scale of faces.

15. The electronic device of claim 14, wherein the face detection model is trained by:
obtaining a preset face detection training sample set;
allocating face detection boxes in the face detection training sample set to N detection box groups each corresponding to the individual scale of faces, wherein the n-th detection box group corresponds to the n-th convolution kernel among the N convolution kernels in the reparameterization module, 1≤n≤N, wherein N is an integer larger than or equal to 2;
determining a training loss of each of the N detection box groups in each training batch; and
obtaining the face detection model by training the face detection model based on the training losses of the N detection box groups.

16. The electronic device of claim 15, wherein the instructions for training the face detection model based on the training losses of the N detection box groups comprise:
instructions for, for a target convolution kernel, determining a gradient of the training loss of each of the N detection box groups, wherein the target convolution kernel is any of the N convolution kernels in the re-parameterization module;
instructions for determining a total gradient corresponding to the target convolution kernel based on the gradients of the training losses of the N detection box groups and preset gradient weights of the N detection box groups, wherein the gradient weight of the first detection box group is larger than the gradient weight of the second detection box group, the first detection box group is a detection box group corresponding to the target convolution kernel, and the second detection box group is one of the N detection box groups other than the first detection box group; and
instructions for adjusting, based on the total gradient corresponding to the target convolution kernel, a model parameter of the target convolution kernel.

17. The electronic device of claim 16, wherein the reparameterization module includes a first convolution kernel, a second convolution kernel, and a third convolution kernel, and the face at the scale corresponding to the first convolution kernel is larger than the face at the scale corresponding to the second convolution kernel, and the face at the scale corresponding to the second convolution kernel is larger than the face at the scale corresponding to the third convolution kernel;
the instructions for determining the total gradient corresponding to the target convolution kernel based on the gradients of the training losses of the N detection box groups and preset gradient weights of the N detection box groups comprise:
instructions for determining, based on the gradient of the training loss of the first detection box group and a first gradient weight of the first detection box group, a first weighted gradient of the first detection box group in response to the target convolution kernel being the first convolution kernel, wherein the first detection box group is a detection box group corresponding to the first convolution kernel;
instructions for determining, based on the gradient of the training loss of the second detection box group and a first gradient weight of the second detection box group, a first weighted gradient of the second detection box group, wherein the second detection box group is a detection box group corresponding to the second convolution kernel;
instructions for determining, based on the gradient of the training loss of a third detection box group and a first gradient weight of the third detection box group, a first weighted gradient of the third detection box group, wherein the third detection box group is a detection box group corresponding to the third convolution kernel; and
instructions for determining, based on the first weighted gradient of the first detection box group, the first weighted gradient of the second detection box group, and the first weighted gradient of the third detection box group, a total gradient corresponding to the first convolution kernel.

18. The electronic device of claim 17, wherein the instructions for determining the total gradient corresponding to the target convolution kernel based on the gradients of the training losses of the N detection box groups and preset gradient weights of the N detection box groups further comprise:
instructions for determining, based on the gradient of the training loss of the first detection box group and a second gradient weight of the first detection box group, a second weighted gradient of the first detection box group in response to the target convolution kernel being the second convolution kernel;
instructions for determining, based on the gradient of the training loss of the second detection box group and a second gradient weight of the second detection box group, a second weighted gradient of the second detection box group;
instructions for determining, based on the gradient of the training loss of the third detection box group and a second gradient weight of the third detection box group, a second weighted gradient of the third detection box group; and
instructions for determining, based on the second weighted gradient of the first detection box group, the second weighted gradient of the second detection box group, and the second weighted gradient of the third detection box group, a total gradient corresponding to the second convolution kernel.

19. The electronic device of claim 17, wherein the instructions for determining the total gradient corresponding to the target convolution kernel based on the gradients of the training losses of the N detection box groups and preset gradient weights of the N detection box groups further comprise:
instructions for determining, based on the gradient of the training loss of the first detection box group and a third gradient weight of the first detection box group, a third weighted gradient of the first detection box group in response to the target convolution kernel being the third convolution kernel;
instructions for determining, based on the gradient of the training loss of the second detection box group and a third gradient weight of the second detection box group, a third weighted gradient of the second detection box group;
instructions for determining, based on the gradient of the training loss of the third detection box group and a third gradient weight of the third detection box group, a third weighted gradient of the third detection box group; and
instructions for determining, based on the third weighted gradient of the first detection box group, the third weighted gradient of the second detection box group, and the third weighted gradient of the third detection box group, a total gradient corresponding to the third convolution kernel.

20. The electronic device of claim 14, wherein the convolution kernel in the reparameterization module that corresponds to the face at the minimum scale is a center differential convolution kernel.
